(19) United States
(12) Patent Application Publication
(10) Pub. No.: US 2025/0072409 A1
(43) Pub. Date: Mar. 6, 2025

(54) FISHING APPARATUS FOR FACILITATING FISHING

(71) Applicant: Ricky Darrell Kelly, JR., Miami, FL (US)

(72) Inventor: Ricky Darrell Kelly, JR., Miami, FL (US)

(21) Appl. No.: 18/810,582

(22) Filed: Aug. 21, 2024

Related U.S. Application Data
(60) Provisional application No. 63/535,345, filed on Aug. 30, 2023.

(51) Int. Cl. A01K 89/08; A01K 89/017; A01K 91/02

(52) U.S. Cl. CPC A01K 89/08; A01K 89/017; A01K 91/02

(57) ABSTRACT

Disclosed herein is a fishing apparatus for facilitating fishing, in accordance with some embodiments. Accordingly, the fishing apparatus may include an apparatus body. Further, the apparatus body may be configured to be held by a hand of a user. Further, the apparatus body may be spherically shaped. Further, the apparatus body may include at least one compartment comprised in the apparatus body, and at least one cover attached to the apparatus body. Further, the at least one compartment may be configured for storing at least one item required for fishing in the at least one compartment. Further, the at least one cover may be configured for openably closing the at least one compartment. Further, the apparatus body may be configured to be fitted with a fishing line of at least one length.

### REFERENCE TO RELATED APPLICATIONS

This application claims the benefit of U.S. Provisional Patent Application No. 63/535,345, titled “A HAND-HELD APPARATUS FOR FACILITATING PERFORMING FISHING”, filed 30 Aug. 2023, which is incorporated by reference herein in its entirety.

### FIELD OF THE INVENTION

Generally, the present disclosure relates to the field of fishing, trapping, and vermin destroying. More specifically, the present disclosure relates to a fishing apparatus for facilitating fishing.

### BACKGROUND OF THE INVENTION

The field of fishing, trapping, and vermin destroying is technologically important to several industries, business organizations, and/or individuals. In particular, the use of fishing apparatus is prevalent for fishing.

Existing apparatuses for facilitating fishing are deficient with regard to several aspects. For instance, current apparatuses used for fishing are bulky. As a result, different apparatuses are needed that are compact. Furthermore, current apparatuses used for fishing are difficult to carry. As a result, different apparatuses are needed that may easily carried.

Therefore, there is a need for an improved fishing apparatus for facilitating fishing that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a fishing apparatus for facilitating fishing, in accordance with some embodiments. Accordingly, the fishing apparatus may include an apparatus body. Further, the apparatus body may be configured to be held by a hand of a user. Further, the apparatus body may be spherically shaped. Further, the apparatus body may include at least one compartment comprised in the apparatus body, and at least one cover attached to the apparatus body. Further, the at least one compartment may be configured for storing at least one item required for fishing in the at least one compartment. Further, the at least one cover may be configured for openably closing the at least one compartment. Further, the apparatus body may be configured to be fitted with a fishing line of at least one length.

Further disclosed herein is a fishing apparatus for facilitating fishing, in accordance with some embodiments. Accordingly, the fishing apparatus may include an apparatus body and a holder. Further, the apparatus body may be configured to be held by a hand of a user. Further, the apparatus body may be spherically shaped. Further, the apparatus body may include at least one compartment comprised in the apparatus body, and at least one cover attached to the apparatus body. Further, the at least one compartment may be configured for storing at least one item required for fishing in the at least one compartment. Further, the at least one cover may be configured for openably closing the at least one compartment. Further, the apparatus body may be configured to be fitted with a fishing line of at least one length. Further, the holder may be comprised in the apparatus body. Further, the holder may be configured for holding the fishing line of the at least one length. Further, the fitting of the fishing line may be based on the holding.

Further disclosed herein is a fishing apparatus for facilitating fishing, in accordance with some embodiments. Accordingly, the fishing apparatus may include an apparatus body. Further, the apparatus body may be configured to be held by a hand of a user. Further, the apparatus body may be spherically shaped. Further, the apparatus body may include at least one compartment comprised in the apparatus body, and at least one cover attached to the apparatus body. Further, the at least one compartment may be configured for storing at least one item required for fishing in the at least one compartment. Further, the at least one cover may be configured for openably closing the at least one compartment. Further, the apparatus body may be configured to be fitted with a fishing line of at least one length. Further, the apparatus body may be characterized by a body diameter. Further, the body diameter ranges from 3 inches to 5 inches.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a left side bottom view of a fishing apparatus 100 for facilitating fishing, in accordance with some embodiments.

FIG. 2 is a left side perspective view of the fishing apparatus 100, in accordance with some embodiments.

FIG. 3 is a left side view of the fishing apparatus 100, in accordance with some embodiments.

FIG. 4 is a top left side perspective view of the fishing apparatus 100, in accordance with some embodiments.

FIG. 5 is a top perspective view of the fishing apparatus 100, in accordance with some embodiments.

FIG. 6 is a left side bottom view of the fishing apparatus 100 without the at least one cover 106, in accordance with some embodiments.

FIG. 7 is a front perspective view of the at least one cover 106 of the fishing apparatus 100, in accordance with some embodiments.

FIG. 8 is a left side bottom view of the fishing apparatus 100 with the at least one item 802 stored in the at least one compartment 104, in accordance with some embodiments.

FIG. 9 is a right side bottom view of the fishing apparatus 100, in accordance with some embodiments.

FIG. 10 is a right side view of the fishing apparatus 100 held by the hand 1002 of the user, in accordance with some embodiments.

FIG. 11 is a bottom perspective view of the fishing apparatus 100 held by the hand 1002 of the user, in accordance with some embodiments.

FIG. 12 is a right side bottom view of the fishing apparatus 100 with the at least one item 802 stored in the at least one compartment 104, in accordance with some embodiments.

FIG. 13 is a front perspective view of a fishing apparatus 1300 for facilitating fishing, in accordance with some embodiments.

FIG. 14 is a top rear perspective view of the fishing apparatus 1300, in accordance with some embodiments.

FIG. 15 is a left side bottom view of a fishing apparatus 1500 for facilitating fishing, in accordance with some embodiments.

FIG. 16 is a left side bottom view of a fishing apparatus 1600 for facilitating fishing, in accordance with some embodiments.

FIG. 17 is a flow chart of a method 1700 of facilitating performing fishing using a hand-held apparatus, in accordance with some embodiments.

FIG. 18 is a block diagram of a system 1800 of facilitating performing fishing using a hand-held apparatus 1808, in accordance with some embodiments.

FIG. 19 is an illustration of an online platform 1900 consistent with various embodiments of the present disclosure.

FIG. 20 is a block diagram of a computing device 2000 for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a fishing apparatus for facilitating fishing, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

### Overview

The present disclosure describes a fishing apparatus for facilitating fishing.

Further, the fishing apparatus may be a hand-held apparatus for facilitating performing fishing. Further, the hand-held apparatus may include built-in storage compartments for fishing sinkers, hooks, etc. Further, the hand-held apparatus may be characterized by a spherical shape.

Further, the disclosed apparatus allows a user to fish on the go without the need to carry a bulky rod or fishing reel. Further, the disclosed apparatus may be perfect for a day out with friends and family on the water. Further, with the built-in compartments, the user may be able to store hooks, sinkers, and so on that may be needed. Further, the apparatus may fit a natural curvature of a hand of the user to maximize grip effort. Further, the apparatus may be fitted with up to 50 yards of 2-to-8-pound fishing line.

Further, in an instance, a diameter of the hand-held apparatus may range in size from 3 to 5 inches depending on a size of the hand. Further, as opposed to using a traditional fishing rod or reel, the disclosed compact fishing apparatus is portable and with its built-in storage compartment, allows for storage of hooks, sinkers, etc. Further, the apparatus may naturally fit the shape or curvature of the hand (or human hand) which makes the apparatus extremely comfortable to use over a long period.

Further, the apparatus may include a strap to hold the hand to the apparatus and cushions for the fingers to provide maximum comfort.

Further, the present disclosure describes a hand-held apparatus for facilitating performing fishing. Further, the hand-held apparatus may include at least one built-in compartment for accommodating at least one item required during fishing. Further, the at least one item may include fishing sinkers, hooks, etc. Further, the hand-held apparatus may include at least one cover for openably covering the at least one built-in compartment. Further, in some embodiments, the at least one cover may snugly fit along a top edge of the at least one built-in compartment. Further, in some embodiments, a first edge of the at least cover may be detachably attachable to the hand-held apparatus by using a fastening mechanism. Further, the fastening mechanism may include a glue, a Velcro, etc. Further, the at least one cover may be transitioned between a closed state and an open state. Further, the at least one built-in compartment may be accessible to the user in the open state. Further, the at least one built-in compartment may not be accessible to the user in the closed state. Further, in some embodiments, the fastening mechanism may be disposed around a periphery of the at least one built-in compartment. Further, the hand-held apparatus may be characterized by a spherical shape. Further, the hand-held apparatus may fit a natural curvature of a hand of the user to maximize grip effort. Further, the hand-held apparatus may include a strap to hold or secure the hand-held apparatus to the hand of the user. Further, the hand-held apparatus may include a cushioned portion for fingers and thumb to provide maximum comfort. Further, the hand-held apparatus may be fitted with up to 50 yards of 2-to-8-pound fishing line. Further, in an instance, a diameter of the hand-held apparatus may range in size from 3 to 5 inches depending on a size of the hand.

Further, the hand-held apparatus may be made up of a soft material. Further, the soft material may include at least one of a foam, rubber, elastane, polymer, artificial fiber, etc.

Further, the hand-held apparatus may be made up of water-proof material that may not be damaged by exposure to water and heat.

Further, the at least one cover may include a waterproof layer attached along a periphery of the at least one cover. Further, the waterproof layer may prevent the water from entering the at least one built-in compartment.

Further, the present disclosure relates generally to fishing devices. More specifically, the present disclosure describes a hand-held apparatus for facilitating performing fishing

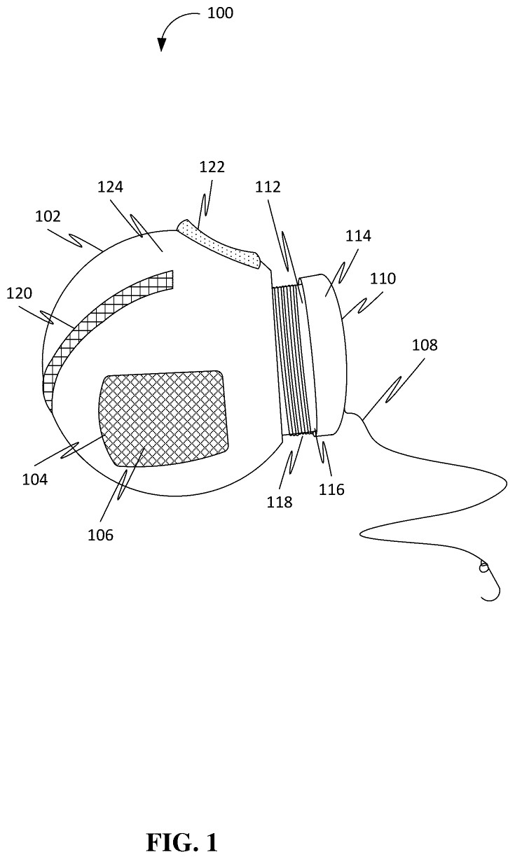

FIG. 1 is a left side bottom view of a fishing apparatus 100 for facilitating fishing, in accordance with some embodiments. Accordingly, the fishing apparatus 100 may include an apparatus body 102. Further, the fishing apparatus 100 may include a hand-held apparatus.

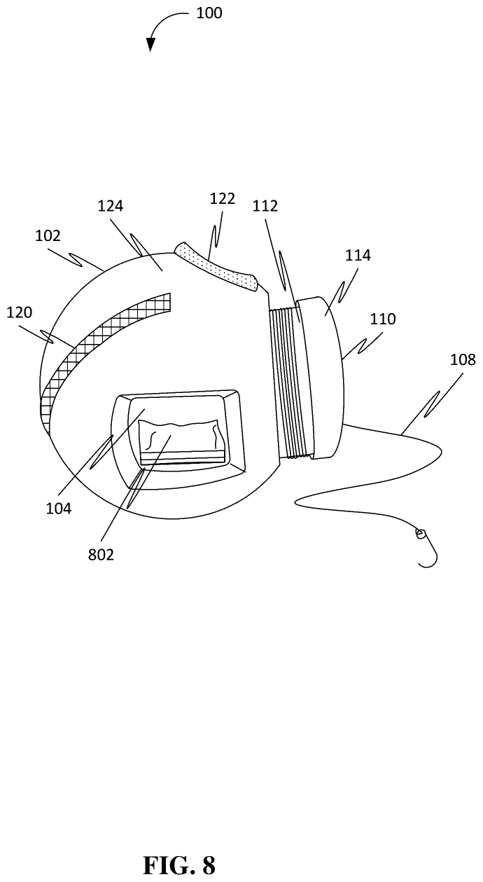

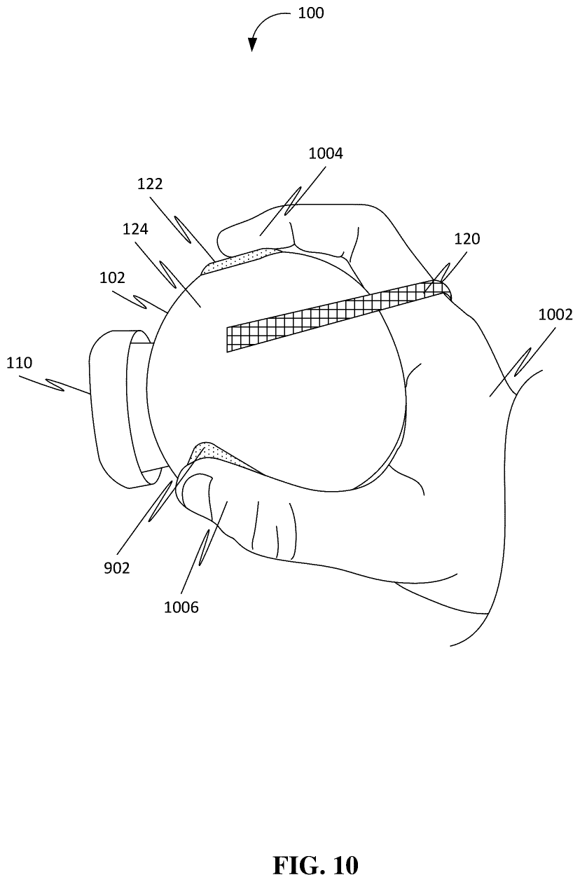

Further, the apparatus body 102 may be configured to be held by a hand 1002, as shown in FIG. 10, of a user. Further, the user may include an individual, a person, etc. Further, the apparatus body 102 may be spherically shaped. Further, the apparatus body 102 may be substantially spherical, round, etc. Further, the apparatus body 102 may include at least one compartment 104 comprised in the apparatus body 102, and at least one cover 106 attached to the apparatus body 102. Further, the at least one compartment 104 may include an interior space in the apparatus body 102 defined by an interior surface of the apparatus body 102 and a compartment opening leading into the interior space. Further, the interior space may include a hollowed out space in the apparatus body 102. Further, the at least one compartment 104 may be configured for storing at least one item 802, as shown in FIG. 8, required for fishing in the at least one compartment 104. Further, the at least one item 802 may include a fishing hook, a sinker, a swivel, a bait, etc. Further, the at least one cover 106 may be configured for openably closing the at least one compartment 104. Further, the at least one cover 106 may include a lid. Further, the at least one cover 106 may be configured for coverably uncovering the compartment opening based on transitioning between a plurality of positions in relation to the compartment opening for the openably closing the at least one compartment 104. Further, the apparatus body 102 may be configured to be fitted with a fishing line 108 of at least one length. Further, the fishing line 108 may include a 2 to 8-pound fishing line. Further, the at least one length may be at least 50 yards.

In further embodiments, the fishing apparatus 100 may include a holder 110 comprised in the apparatus body 102. Further, the holder 110 may be configured for holding the fishing line 108 of the at least one length. Further, the fitting of the fishing line 108 may be further based on the holding.

Further, in an embodiment, the holder 110 may include a shaft 112 and a cap 114 comprised in a distal end 116 of the shaft 112. Further, the shaft 112 may include a tube, a rod, etc. Further, the shaft 112 may include an elongated cylindrical body. Further, the cap 114 may be an end cap. Further, the cap 114 may include a circular disc. Further, at least a portion of the shaft 112 extends from the apparatus body 102. Further, at least the portion of the shaft extends away from the apparatus body 102. Further, at least the portion of the shaft 112 may be proximal to the distal end 116. Further, the shaft 112 may be attached to the apparatus body 102. Further, at least a portion of the shaft 112 proximal to a proximal end of the shaft 112 may be attached to the apparatus body 102. Further, the shaft 112 and the cap 114 define a recess 118 of the holder 110. Further, the holding of the fishing line 108 may include holding the fishing line 108 in the recess 118 of the holder 110.

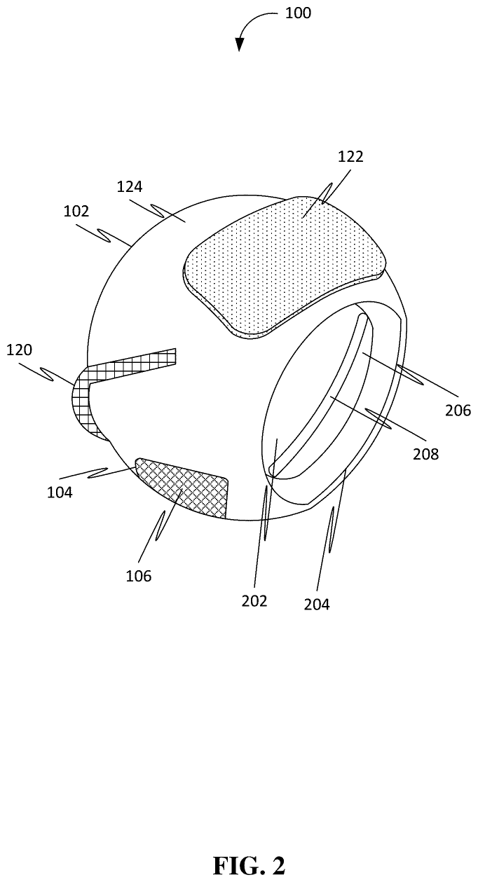

Further, in an embodiment, the shaft 112 may be characterized by a shaft diameter. Further, the cap 114 may be characterized by a cap diameter. Further, the shaft diameter may be less than the cap diameter. Further, the recess 118 may be defined around the shaft 112. Further, the recess 118 may be defined around at least the portion of the shaft 112. Further, in an embodiment, the apparatus body 102 may include an interior space 202 and an opening 204, as shown in FIG. 2, leading into the interior space. Further, the apparatus body 102 may include an opening periphery defining the opening 204. Further, the shaft 112 may be attached to an interior surface 206, as shown in FIG. 2, of the interior space 202. Further, at least the portion of the shaft 112 extends from the apparatus body 102 through the opening 204. Further, in an embodiment, the shaft 112 may be movably attached to the interior surface 206 of the interior space 202 using at least one attachment element 208, as shown in FIG. 2. Further, the at least one attachment element 208 may include at least one bearing. Further, an outer race of the at least one bearing may be attached to the interior surface 206 and an inner race of the at least one bearing may be attached to an outer surface of the shaft 112. Further, the at least one bearing may allow a rotatory movement for the inner race in relation to the outer race, and a translator movement for the inner race in relation to the outer race. Further, the at least one bearing may include a combined linear and rotary bearing. Further, the holder 110 may be configured to be transitioned between a retracted position and at least one extended position based on the movably attaching of the shaft 112 to the interior surface 206. Further, at least the portion of the shaft 112 extends from the apparatus body 102 through the opening 204 in the at least one extended state. Further, at least the portion of the shaft 112 may be disposed in the interior space 202 in the retracted state.

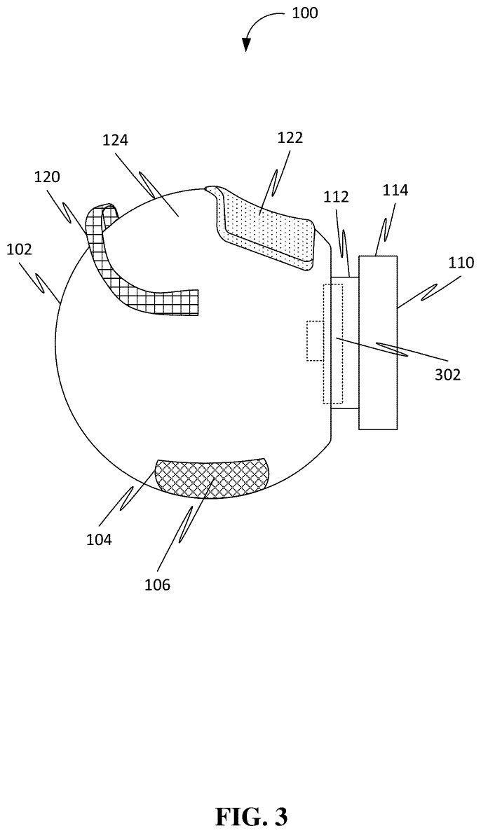

Further, in an embodiment, the fishing line 108 may be wound around the shaft 112 based on the holding of the fishing line 108 in the recess 118 of the holder 110. Further, the apparatus may include a winding mechanism 302, as shown in FIG. 3, comprised in the apparatus body 102. Further, the winding mechanism 302 may be configured for at least one of winding and unwinding the fishing line 108 from the shaft 112. Further, in an embodiment, the winding mechanism 302 may include a motor. Further, the motor may be electrically powered. Further, a motor shaft of the motor may be mechanically coupled with the shaft 112. Further, the shaft 112 may be rotatably attached to the apparatus body 102. Further, the motor may be configured for rotating the shaft 112 in at least one of a clockwise direction and a counter clockwise direction with at least one rotational characteristic. Further, at least one of the winding and the unwinding of the fishing line 108 on the shaft 112 may be based on the rotating of the shaft 112 in at least one of the clockwise direction and the counterclockwise direction. Further, the at least one rotational characteristic may include a speed of rotation, a direction of rotation, an instance of rotation, etc.

In further embodiments, the fishing apparatus 100 may include a strap 120 attached to the apparatus body 102. Further, the strap 120 may be configured for allowing securing the hand 1002 to the apparatus body 102. Further, the strap 120 forms a loop around at least a portion of the hand 1002 of the user for the allowing of the securing of the hand 1002 to the apparatus body 102.

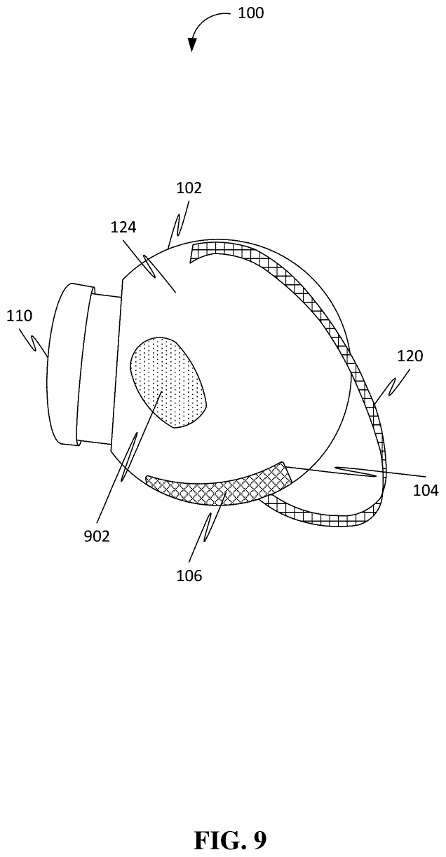

In further embodiments, the fishing apparatus 100 may include at least one cushion element (122 and 902 (as shown in FIG. 9)) disposed in at least one location on a surface 124 of the apparatus body 102. Further, the at least one cushion element (122 and 902) provides comfort for at least one finger 1004-1006, as shown in FIG. 10, of the hand 1002 of the user while holding the apparatus body 102. Further, the at least one cushion element (122 and 902) may be comprised of polyurethane, latex, etc. Further, the at least one cushion element (122 and 902) may be comprised of at least one material that provides cushioning properties. Further, the at least one cushion element (122 and 902) may include a flattened body characterized by a body thickness.

Further, in an embodiment, the at least one cushion element (122 and 902) may be removably attached in the at least one location on the surface 124 of the apparatus body 102. Further, the surface 124 may be an outer surface of the apparatus body 102. Further, in an embodiment, the at least one location corresponds to a location of the at least one finger 1004-1006 on the surface 124 of the apparatus body 102 while holding the apparatus body 102 with the hand 1002. Further, the location of the at least one finger 1004-1006 may correspond to a location of a tip portion of the at least one finger 1004-1006. Further, the at least one cushion element (122 and 902) may include a layer of at least one adhesive on an attaching surface of the at least one cushion element (122 and 902). Further, the attaching surface of the at least one cushion element (122 and 902) removably attaches to the surface 124 based on the layer of the at least one adhesive. Further, the at least one adhesive may be a removable and reusable adhesive.

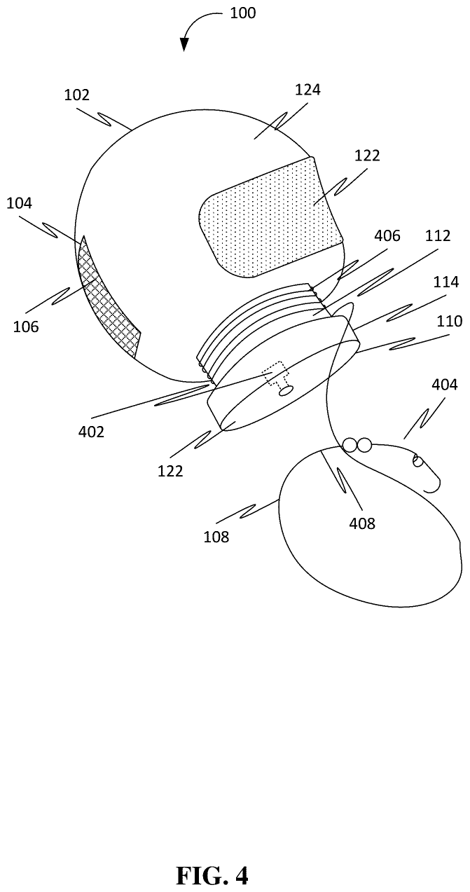

In an embodiment, the fishing apparatus 100 may include a casting mechanism 402, as shown in FIG. 4, comprised in the apparatus body 102. Further, the casting mechanism 402 may be configured for propelling the fishing line 108 comprising a lure 404, as shown in FIG. 4. Further, the fishing line 108 may be secured to the holder 110 at a first end 406, as shown in FIG. 4, of the fishing line 108. Further, the fishing line 108 may be secured to the lure 404 at a second end 408, as shown in FIG. 4, of the fishing line 108. Further, the propelling may include casting, throwing, ejecting, pushing, discharging, etc., of the fishing line 108. Further, the prolleing of the fishing line 108 may include propelling the fishing line 108 propelling the fishing line 108 through the second end 408 of the fishing line 108. Further, in an embodiment, the casting mechanism 402 may include a spring loaded mechanism. Further, the spring loaded mechanism is configured to be transitioned from a compressed state to at least one extended state based on an actuation of the spring loaded mechanism. Further, the propelling of the fishing line 108 may be based on the transitioning of the spring loaded mechanism from the compressed state to the at least one extended state. Further, in an embodiment, the casting mechanism 402 may include a pneumatic propelling mechanism. Further, the pneumatic propelling mechanism may include a discharge port fluidly coupled with a propelling port comprised in the cap 114 of the holder 110. Further, the pneumatic propelling mechanism draw an air intake and flushes the air through the discharge port based on an actuation of the pneumatic propelling mechanism. Further, the second end 408 of the fishing line 108 comprising the lure 404 may be disposed in the propelling port. Further, the flushing of the air propels the fishing line 108.

Further, in some embodiments, the apparatus body 102 may be characterized by a body diameter. Further, the body diameter ranges from 3 inches to 5 inches.

Further, in some embodiments, the apparatus body 102 may be comprised of at least one material. Further, the apparatus body 102 floats on water based on the at least one material. Further, a density of the at least one material may be less than a density of the water of at least one water body. Further, the at least one water body may include a pond, a lake, a river, etc. Further, the at least one material may include plastic, rubber, etc.

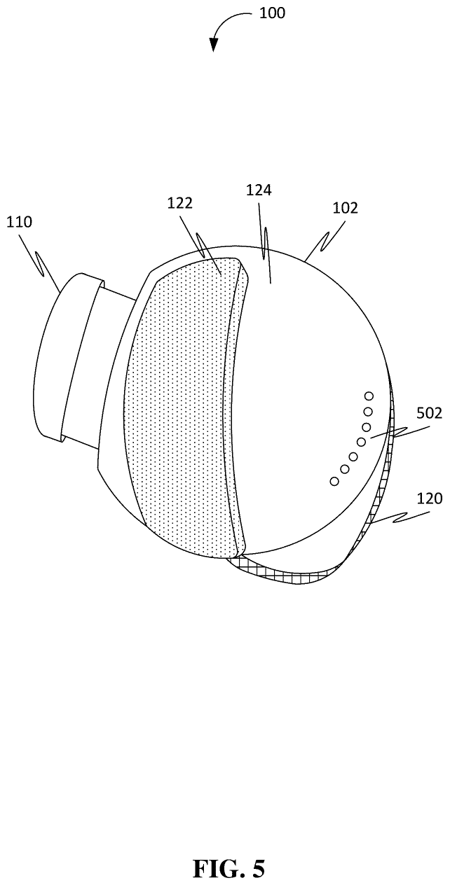

Further, in some embodiments, the apparatus body 102 may include at least one surface feature 502, as shown in FIG. 5, on at least a portion of the surface 124 of the apparatus body 102. Further, the at least one surface feature 502 allows a grabbing of the apparatus body 102 by the hand 1002 of the user. Further, the at least one surface feature 502 may include a texture, an indent, a protrusion, a coating, etc. Further, the at least one surface feature 502 may include at least a pattern of the indent, the protrusion, the coating, etc. Further, the pattern may include a ribbed pattern, a dimpled pattern, a herringbone pattern, etc.

Further, in some embodiments, the apparatus body 102 may be comprised of at least one material. Further, the at least one material allows the apparatus body 102 to be deformed from an original shape to at least one shape based on an application of a force on the apparatus body 102 by the hand 1002 of the user. Further, the at least one shape complements a shape of a palm of the hand 1002 in a grabbing posture of the palm of the hand 1002. Further, in an embodiment, the at least one material may include at least one shape memory material. Further, the at least one shape memory material allows the apparatus body 102 to be restored to the original shape from the at least one shape based on a stimulus provided to the at least one shape memory material. Further, the stimuls may include heat, water, pH level, etc. Further, the at least one shape memory material may include a hydro-responsive shape-memory material. Further, the hydro-responsive shape-memory material may include hydrogel-based shape-memory polymers. Further, the hydrogel-based shape-memory polymers may include Poly(acrylic acid) (PAA) Hydrogels Poly(vinyl alcohol) (PVA) Hydrogels, Poly(ethylene glycol) (PEG) Hydrogels, Polyurethane-Based Hydrogels, etc.

FIG. 2 is a left side perspective view of the fishing apparatus 100, in accordance with some embodiments.

FIG. 3 is a left side view of the fishing apparatus 100, in accordance with some embodiments.

FIG. 4 is a top left side perspective view of the fishing apparatus 100, in accordance with some embodiments.

FIG. 5 is a top perspective view of the fishing apparatus 100, in accordance with some embodiments.

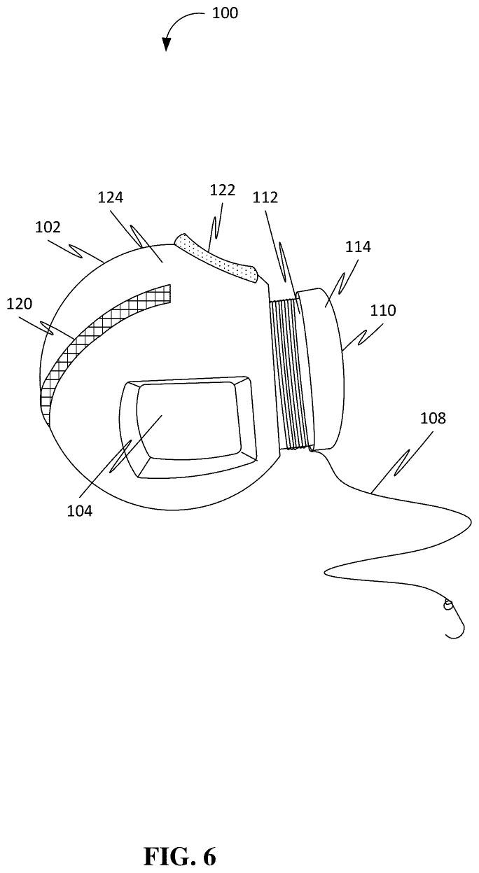

FIG. 6 is a left side bottom view of the fishing apparatus 100 without the at least one cover 106, in accordance with some embodiments.

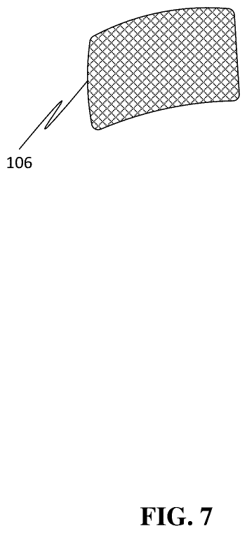

FIG. 7 is a front perspective view of the at least one cover 106 of the fishing apparatus 100, in accordance with some embodiments.

FIG. 8 is a left side bottom view of the fishing apparatus 100 with the at least one item 802 stored in the at least one compartment 104, in accordance with some embodiments.

FIG. 9 is a right side bottom view of the fishing apparatus 100, in accordance with some embodiments.

FIG. 10 is a right side view of the fishing apparatus 100 held by the hand 1002 of the user, in accordance with some embodiments.

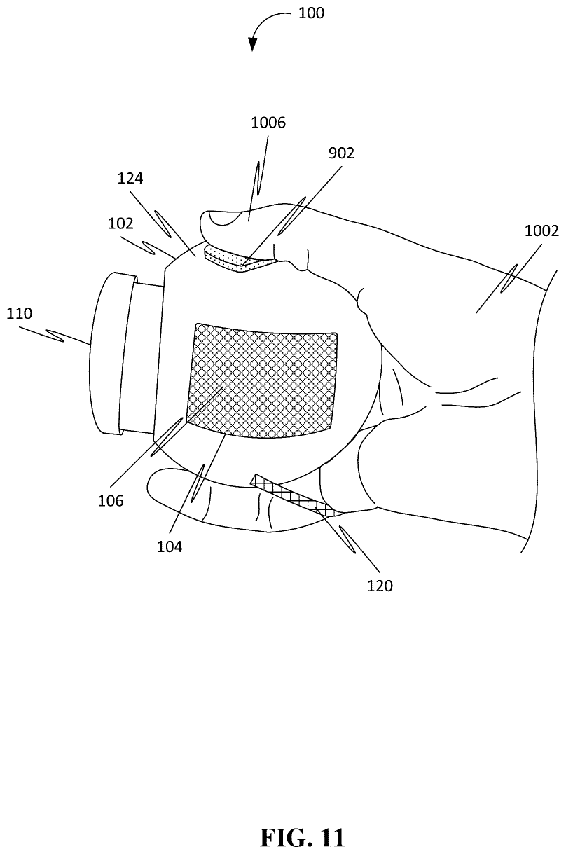

FIG. 11 is a bottom perspective view of the fishing apparatus 100 held by the hand 1002 of the user, in accordance with some embodiments.

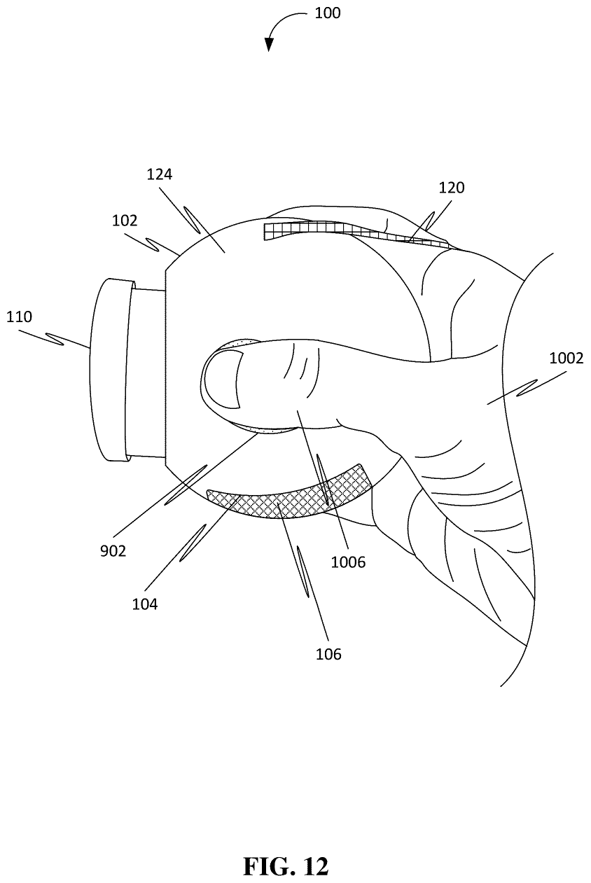

FIG. 12 is a right side bottom view of the fishing apparatus 100 with the at least one item 802 stored in the at least one compartment 104, in accordance with some embodiments.

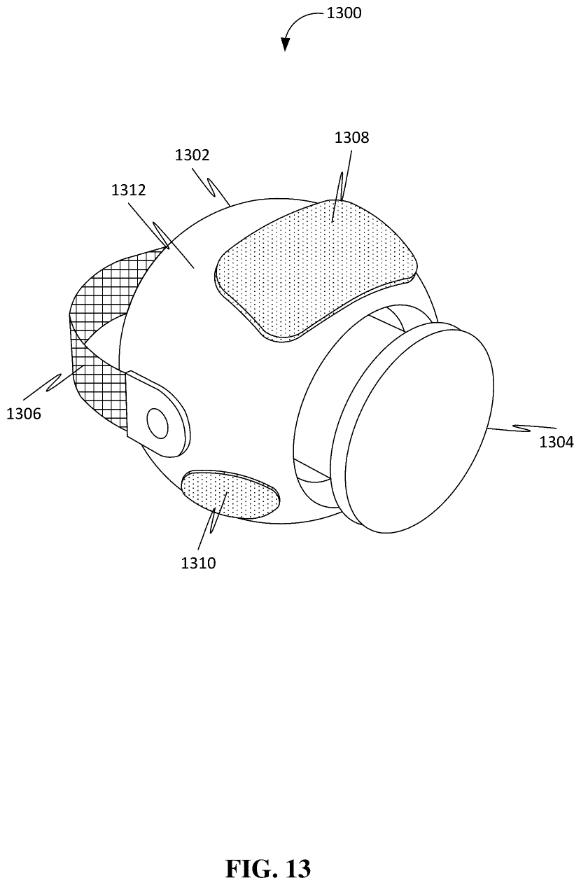

FIG. 13 is a front perspective view of a fishing apparatus 1300 for facilitating fishing, in accordance with some embodiments. Further, the fishing apparatus 1300 may include an apparatus body 1302, a holder 1304, a strap 1306, and at least one cushion element 1308-1310. Further, the at least one cushion element 1308-1310 may be attached to a surface 1312 of the body 1302 in at least one location on the apparatus body 1302.

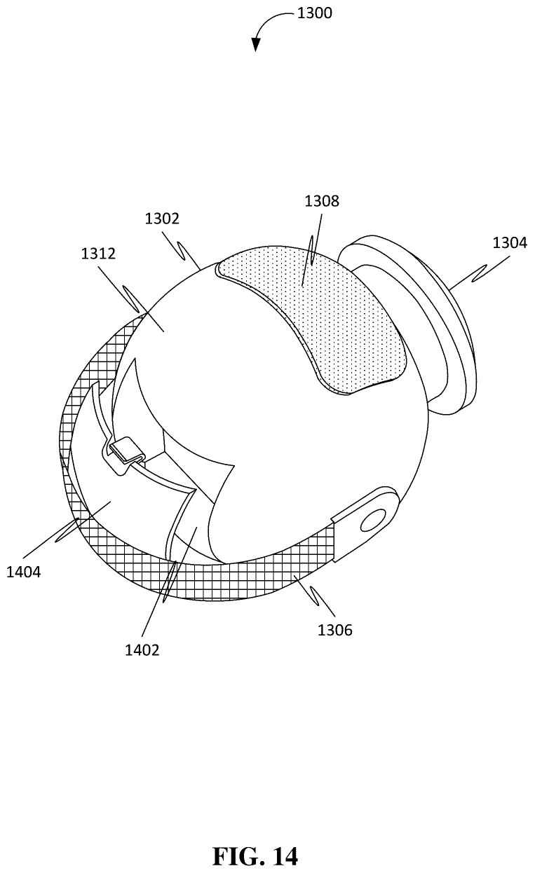

FIG. 14 is a top rear perspective view of the fishing apparatus 1300, in accordance with some embodiments. Further, the fishing apparatus 1300 may include at least one compartment 1402 comprised in the apparatus body 1302, and at least one cover 1404 configured for openably closing the at least one compartment 1402.

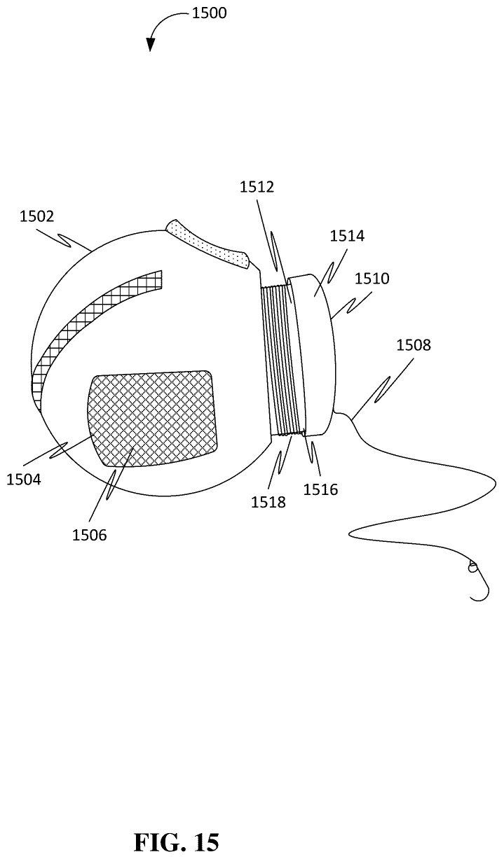

FIG. 15 is a left side bottom view of a fishing apparatus 1500 for facilitating fishing, in accordance with some embodiments. Accordingly, the fishing apparatus 1500 may include an apparatus body 1502 and a holder 1510.

Further, the apparatus body 1502 may be configured to be held by a hand of a user. Further, the apparatus body 1502 may be spherically shaped. Further, the apparatus body 1502 may include at least one compartment 1504 comprised in the apparatus body 1502, and at least one cover 1506 attached to the apparatus body 1502. Further, the at least one compartment 1504 may be configured for storing at least one item required for fishing in the at least one compartment 1504. Further, the at least one cover 1506 may be configured for openably closing the at least one compartment 1504. Further, the apparatus body 1502 may be configured to be fitted with a fishing line 1508 of at least one length.

Further, the holder 1510 may be comprised in the apparatus body 1502. Further, the holder 1510 may be configured for holding the fishing line 1508 of the at least one length. Further, the fitting of the fishing line 1508 may be further based on the holding.

Further, in some embodiments, the holder 1510 may include a shaft 1512 and a cap 1514 comprised in a distal end 1516 of the shaft 1512. Further, at least a portion of the shaft 1512 extends from the apparatus body 1502. Further, the shaft 1512 may be attached to the apparatus body 1502. Further, the shaft 1512 and the cap 1514 defines a recess 1518 of the holder 1510. Further, the holding of the fishing line 1508 may include holding the fishing line 1508 in the recess 1518 of the holder 1510.

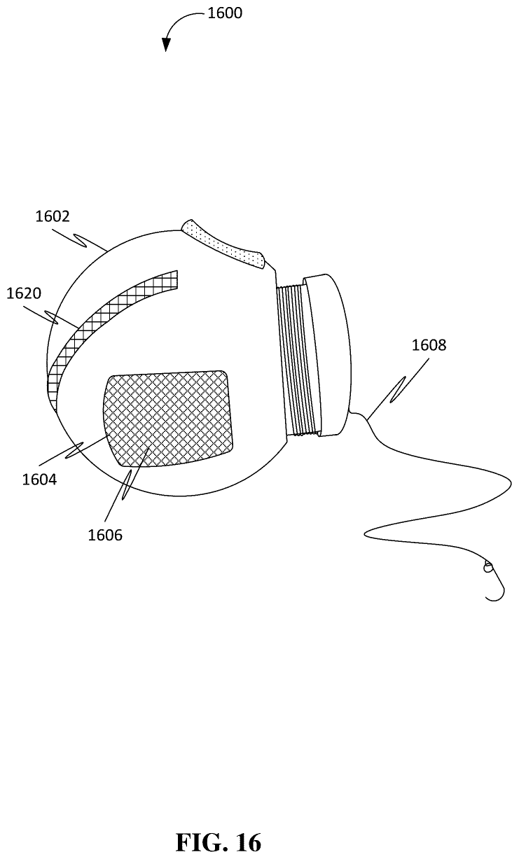

FIG. 16 is a left side bottom view of a fishing apparatus 1600 for facilitating fishing, in accordance with some embodiments. Accordingly, the fishing apparatus 1600 may include an apparatus body 1602.

Further, the apparatus body 1602 may be configured to be held by a hand of a user. Further, the apparatus body 1602 may be spherically shaped. Further, the apparatus body 1602 may include at least one compartment 1604 comprised in the apparatus body 1602, and at least one cover 1606 attached to the apparatus body 1602. Further, the at least one compartment 1604 may be configured for storing at least one item required for fishing in the at least one compartment 1604. Further, the at least one cover 1606 may be configured for openably closing the at least one compartment 1604. Further, the apparatus body 1602 may be configured to be fitted with a fishing line 1608 of at least one length. Further, the apparatus body 1602 may be characterized by a body diameter. Further, the body diameter ranges from 3 inches to 5 inches.

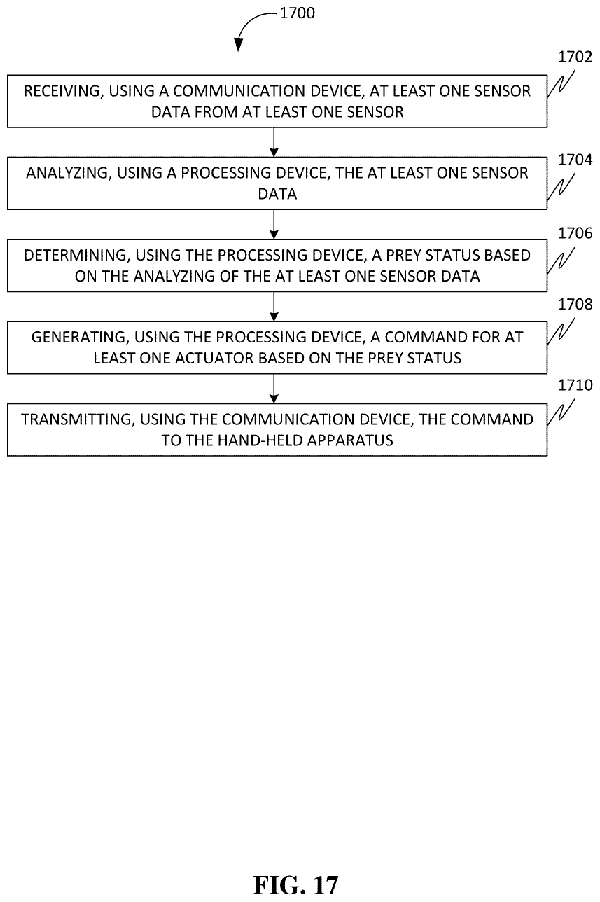

FIG. 17 is a flow chart of a method 1700 of facilitating performing fishing using a hand-held apparatus, in accordance with some embodiments. Accordingly, at 1702, the method 1700 may include receiving, using a communication device, at least one sensor data from at least one sensor. Further, the at least one sensor may be configured for generating the at least one sensor data. Further, the at least one sensor may include an audio sensor, a pressure sensor, a force sensor, an image sensor, a motion sensor, an orientation sensor, an accelerometer, a gyroscope, etc. Further, in an embodiment, the at least one sensor may be disposed in the hand-held apparatus.

Further, at 1704, the method 1700 may include analyzing, using a processing device, the at least one sensor data.

Further, at 1706, the method 1700 may include determining, using the processing device, a prey status based on the analyzing of the at least one sensor data. Further, the prey status may indicate if at least one prey is caught in a hook comprised in the hand-held apparatus.

Further, at 1708, the method 1700 may include generating, using the processing device, a command for at least one actuator based on the prey status.

Further, at 1710, the method 1700 may include transmitting, using the communication device, the command to the hand-held apparatus. Further, the hand-held apparatus may include the at least one actuator configured for retracting a wire with the hook using a wire retracting mechanism based on the command. Further, the wire retracting mechanism may include a spindle rotatable about an axis by a motor. Further, the motor may be configured for performing one of winding and unwinding the wire around the spindle. Further, the wire may be wound around the spindle. Further, the retracting or winding of the wire around the spindle may bring the at least one prey proximal to the user.

Further, in some embodiments, the prey status may include a positive status indicating the at least one prey being caught in the hook. Further, the method 1700 may include generating, using the processing device, a notification based on the prey status. Further, the notification may indicate if the at least one prey is caught in the hook. Further, the method 1700 may include transmitting, using the communication device, the notification to the hand-held apparatus and at least one user device associated with at least one user. Further, the hand-held apparatus may include an output device configured for presenting the notification. Further, the notification may include an alarming sound, a light notification, etc. Further, the at least one user device may include a smartphone, a tablet, a laptop, etc. Further, the at least one user may include an individual that may want to perform fishing using the hand-held apparatus.

Further, in some embodiments, the at least one sensor may include an image sensor, a thermal sensor, a temperature sensor, an acoustic sensor, etc. Further, the method 1700 may include determining, using the processing device, an environment information associated with an environment based on the analyzing of the at least one sensor data. Further, the environment information may include a water temperature, a water speed, a water viscosity, water pathology information, a wind speed, etc. Further, the environment information may include at least one prey information associated with the at least one prey. Further, the water pathology information may include a microbe information associated with at least one microbe. Further, the at least one microbe may include a bacteria, a fungi, a virus, etc. Further, the at least one prey information may include a prey name, a prey image, etc. Further, the method 1700 may include transmitting, using the communication device, the environment information to the at least one user device.

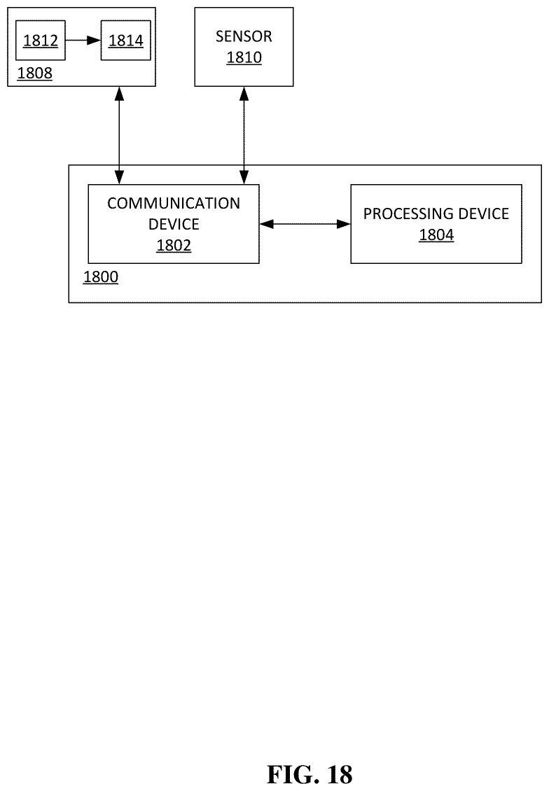

FIG. 18 is a block diagram of a system 1800 of facilitating performing fishing using a hand-held apparatus 1808, in accordance with some embodiments. Accordingly, the system 1800 may include a communication device 1802 configured for receiving at least one sensor data from at least one sensor 1810. Further, the at least one sensor 1810 may be configured for generating the at least one sensor data. Further, the at least one sensor 1810 may include an audio sensor, a pressure sensor, a force sensor, an image sensor, a motion sensor, an orientation sensor, an accelerometer, a gyroscope, etc. Further, the communication device 1802 may be configured for transmitting a command to the hand-held apparatus 1808. Further, the hand-held apparatus 1808 may include at least one actuator 1812 configured for retracting a wire with the hook using a wire retracting mechanism 1814 (such as the winding mechanism) based on the command. Further, the wire retracting mechanism 1814 may include a spindle rotatable about an axis. Further, the wire may be wound around the spindle. Further, the retracting of the wire may bring the at least one prey proximal to the at least one user.

Further, the system 1800 may include a processing device 1804 configured for analyzing the at least one sensor data. Further, the processing device 1804 may be configured for determining a prey status based on the analyzing of the at least one sensor data. Further, the prey status may indicate if at least one prey is caught in a hook comprised in the hand-held apparatus 1808. Further, the processing device 1804 may be configured for generating the command for the at least one actuator 1812 based on the prey status.

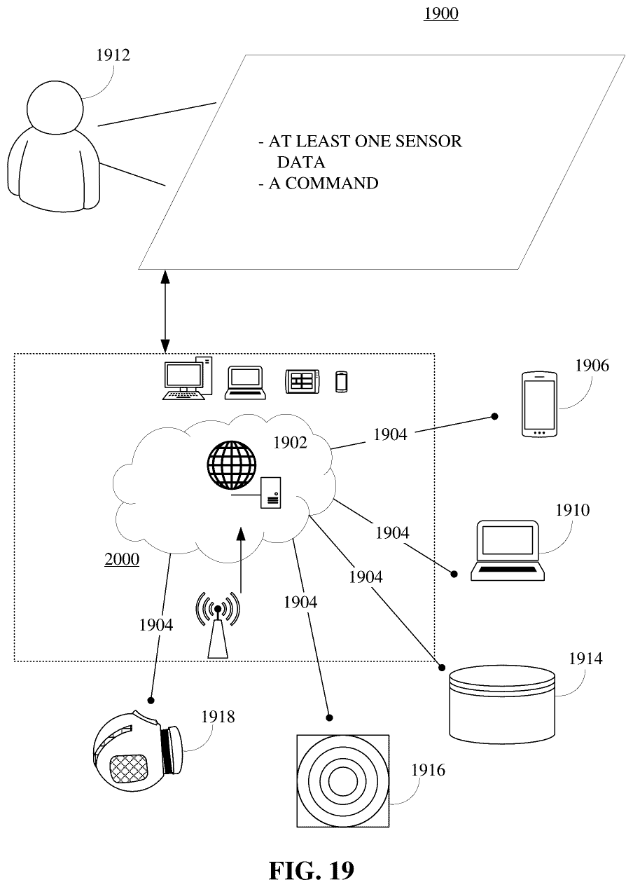

FIG. 19 is an illustration of an online platform 1900 consistent with various embodiments of the present disclosure. By way of non-limiting example, the online platform 1900 to facilitate fishing may be hosted on a centralized server 1902, such as, for example, a cloud computing service. The centralized server 1902 may communicate with other network entities, such as, for example, a mobile device 1906 (such as a smartphone, a laptop, a tablet computer, etc.), other electronic devices 1910 (such as desktop computers, server computers, etc.), databases 1914, sensors 1916, and a fishing apparatus 1918 (such as the fishing apparatus 100, the fishing apparatus 1300, the fishing apparatus 1500, the fishing apparatus 1600, a hand held apparatus, etc.) over a communication network 1904, such as, but not limited to, the Internet. Further, users of the online platform 1900 may include relevant parties such as, but not limited to, end-users, administrators, service providers, service consumers, and so on. Accordingly, in some instances, electronic devices operated by the one or more relevant parties may be in communication with the platform.

A user 1912, such as the one or more relevant parties, may access online platform 1900 through a web based software application or browser. The web based software application may be embodied as, for example, but not be limited to, a website, a web application, a desktop application, and a mobile application compatible with a computing device 2000.

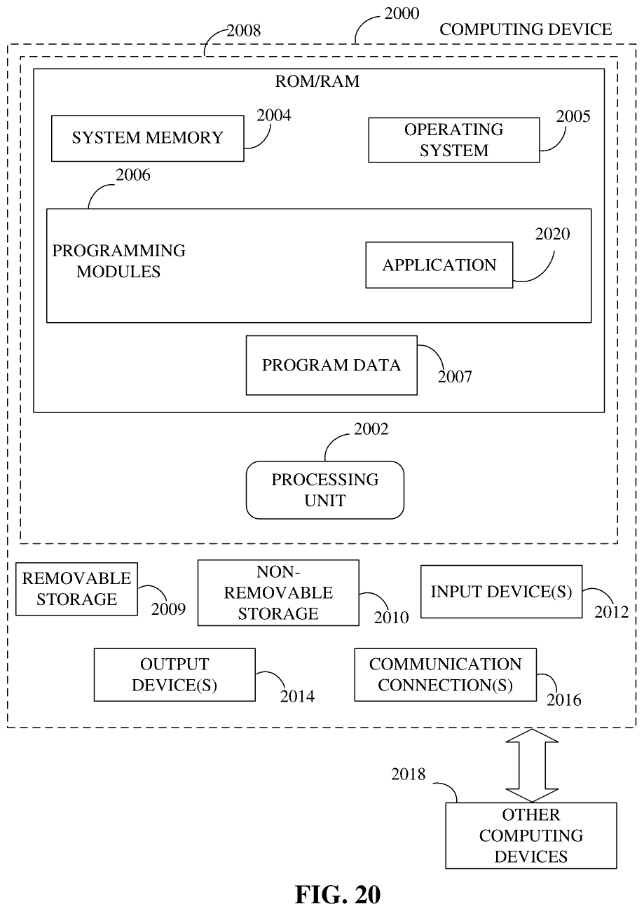

With reference to FIG. 20, a system consistent with an embodiment of the disclosure may include a computing device or cloud service, such as computing device 2000. In a basic configuration, computing device 2000 may include at least one processing unit 2002 and a system memory 2004. Depending on the configuration and type of computing device, system memory 2004 may comprise, but is not limited to, volatile (e.g. random-access memory (RAM)), non-volatile (e.g. read-only memory (ROM)), flash memory, or any combination. System memory 2004 may include operating system 2005, one or more programming modules 2006, and may include a program data 2007. Operating system 2005, for example, may be suitable for controlling computing device 2000's operation. In one embodiment, programming modules 2006 may include image-processing modules, machine learning modules, etc. Furthermore, embodiments of the disclosure may be practiced in conjunction with a graphics library, other operating systems, or any other application program and is not limited to any particular application or system. This basic configuration is illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage is illustrated in FIG. 20 by a removable storage 2009 and a non-removable storage 2010. Computer storage media may include volatile and non-volatile, removable, and non-removable media implemented in any method or technology for storage of information, such as computer-readable instructions, data structures, program modules, or other data. System memory 2004, removable storage 2009, and non-removable storage 2010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, a location sensor, a camera, a biometric sensor, etc. Output device(s) 2014 such as a display, speakers, a printer, etc. may also be included. The aforementioned devices are examples and others may be used.

Computing device 2000 may also contain a communication connection 2016 that may allow device 2000 to communicate with other computing devices 2018, such as over a network in a distributed computing environment, for example, an intranet or the Internet. Communication connection 2016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2004, including operating system 2005. While executing on processing unit 2002, programming modules 2006 (e.g., application 2020 such as a media player) may perform processes including, for example, one or more stages of methods, algorithms, systems, applications, servers, databases as described above. The aforementioned process is an example, and processing unit 2002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A fishing apparatus for facilitating fishing, the fishing apparatus comprising:
an apparatus body configured to be held by a hand of a user, wherein the apparatus body is spherically shaped, wherein the apparatus body comprises at least one compartment comprised in the apparatus body, and at least one cover attached to the apparatus body, wherein the at least one compartment is configured for storing at least one item required for fishing in the at least one compartment, wherein the at least one cover is configured for openably closing the at least one compartment, wherein the apparatus body is configured to be fitted with a fishing line of at least one length.

2. The fishing apparatus of claim 1 further comprises a holder comprised in the apparatus body, wherein the holder is configured for holding the fishing line of the at least one length, wherein the fitting of the fishing line is further based on the holding.

3. The fishing apparatus of claim 2, wherein the holder comprises a shaft and a cap comprised in a distal end of the shaft, wherein at least a portion of the shaft extends from the apparatus body, wherein the shaft is attached to the apparatus body, wherein the shaft and the cap define a recess of the holder, wherein the holding of the fishing line comprises holding the fishing line in the recess of the holder.

4. The fishing apparatus of claim 3, wherein the shaft is characterized by a shaft diameter, wherein the cap is characterized by a cap diameter, wherein the shaft diameter is less than the cap diameter, wherein the recess is defined around the shaft.

5. The fishing apparatus of claim 4, wherein the apparatus body further comprises an interior space and an opening leading into the interior space, wherein the shaft is attached to an interior surface of the interior space, wherein at least the portion of the shaft extends from the apparatus body through the opening.

6. The fishing apparatus of claim 5, wherein the shaft is movably attached to the interior surface of the interior space using at least one attachment element, wherein the holder is configured to be transitioned between a retracted position and at least one extended position based on the movably attaching of the shaft to the interior surface, wherein at least the portion of the shaft extends from the apparatus body through the opening in the at least one extended state, wherein at least the portion of the shaft is disposed in the interior space in the retracted state.

7. The fishing apparatus of claim 3, wherein the fishing line is wound around the shaft based on the holding of the fishing line in the recess of the holder, wherein the apparatus further comprises a winding mechanism comprised in the apparatus body, wherein the winding mechanism is configured for at least one of winding and unwinding the fishing line from the shaft.

8. The fishing apparatus of claim 1 further comprising a strap attached to the apparatus body, wherein the strap is configured for allowing securing the hand to the apparatus body, wherein the strap forms a loop around at least a portion of the hand of the user for the allowing of the securing of the hand to the apparatus body.

9. The fishing apparatus of claim 1 further comprising at least one cushion element disposed in at least one location on a surface of the apparatus body, wherein the at least one cushion element provides comfort for at least one finger of the hand of the user while holding the apparatus body.

10. The fishing apparatus of claim 9, wherein the at least one cushion element is removably attached in the at least one location on the surface of the apparatus body.

11. The fishing apparatus of claim 10, wherein the at least one location corresponds to a location of the at least one finger on the surface of the apparatus body while holding the apparatus body with the hand.

12. The fishing apparatus of claim 2 further comprising a casting mechanism comprised in the apparatus body, wherein the casting mechanism is configured for propelling the fishing line comprising a lure, wherein the fishing line is secured to the holder at a first end of the fishing line, wherein the fishing line is secured to the lure at a second end of the fishing line.

13. The fishing apparatus of claim 1, wherein the apparatus body is characterized by a body diameter, wherein the body diameter ranges from 3 inches to 5 inches.

14. The fishing apparatus of claim 1, wherein the apparatus body is comprised of at least one material, wherein the apparatus body floats on water based on the at least one material.

15. The fishing apparatus of claim 1, wherein the apparatus body comprises at least one surface feature on at least a portion of a surface of the apparatus body, wherein the at least one surface feature allows a grabbing of the apparatus body by the hand of the user.

16. The fishing apparatus of claim 1, wherein the apparatus body is comprised of at least one material, wherein the at least one material allows the apparatus body to be deformed from an original shape to at least one shape based on an application of a force on the apparatus body by the hand of the user, wherein the at least one shape complements a shape of a palm of the hand in a grabbing posture of the palm of the hand.

17. The apparatus of claim 16, wherein the at least one material comprises at least one shape memory material, wherein the at least one shape memory material allows the apparatus body to be restored to the original shape from the at least one shape based on a stimulus provided to the at least one shape memory material.

18. A fishing apparatus for facilitating fishing, the fishing apparatus comprising:
an apparatus body configured to be held by a hand of a user, wherein the apparatus body is spherically shaped, wherein the apparatus body comprises at least one compartment comprised in the apparatus body, and at least one cover attached to the apparatus body, wherein the at least one compartment is configured for storing at least one item required for fishing in the at least one compartment, wherein the at least one cover is configured for openably closing the at least one compartment, wherein the apparatus body is configured to be fitted with a fishing line of at least one length; and
a holder comprised in the apparatus body, wherein the holder is configured for holding the fishing line of the at least one length, wherein the fitting of the fishing line is further based on the holding.

19. The fishing apparatus of claim 18, wherein the holder comprises a shaft and a cap comprised in a distal end of the shaft, wherein at least a portion of the shaft extends from the apparatus body, wherein the shaft is attached to the apparatus body, wherein the shaft and the cap defines a recess of the holder, wherein the holding of the fishing line comprises holding the fishing line in the recess of the holder.

20. A fishing apparatus for facilitating fishing, the fishing apparatus comprising:
an apparatus body configured to be held by a hand of a user, wherein the apparatus body is spherically shaped, wherein the apparatus body comprises at least one compartment comprised in the apparatus body, and at least one cover attached to the apparatus body, wherein the at least one compartment is configured for storing at least one item required for fishing in the at least one compartment, wherein the at least one cover is configured for openably closing the at least one compartment, wherein the apparatus body is configured to be fitted with a fishing line of at least one length, wherein the apparatus body is characterized by a body diameter, wherein the body diameter ranges from 3 inches to 5 inches.
